(19) United States
(12) Patent Application Publication
(10) Pub. No.: US 2004/0215231 A1
(43) Pub. Date: Oct. 28, 2004

(54) Device for the closure of a surgical puncture

(76) Inventors: David Fortune, Leeds (GB); Jose Velada, Hertfordshire (GB); Patrick Trotter, Leeds (GB); David Mandley, North Yorkshire (GB); Peter Edwardson, Leeds (GB)

Correspondence Address: Joseph M Noto, Nixon Peabody, Clinton Square, PO Box 31051, Rochester, NY, 14603, US

(21) Appl. No.: 10/182,044

(22) PCT Filed: Feb. 5, 2001
(86) PCT No.: PCT/GB01/00454

(30) Foreign Application Priority Data
Feb. 3, 2000 (GB) 0002378.8
Feb. 3, 2000 (GB) 0002379.6

(51) Int. Cl. A61D 1/00

(52) U.S. Cl. 606/213

(57) ABSTRACT

There are described devices implantable in the human or animal body. Such a device takes the form of a pre-formed three-dimensional article, comprising at least in part a material which is hydratable and capable of bonding to tissue whilst retaining its integrity. The material may be activated, leading to cross-linking of the material and the formation of chemical bonds between the material and tissue to which it is applied. In preferred embodiments the material has self-adhesive properties. The article may have a wide variety of shapes to suit its intended purpose, and may be manufactured by a variety of methods.

This invention relates to devices intended for implantation in the body in the course of surgical procedures, and to methods involving the use of such devices. The invention relates particularly to implantable devices useful in numerous different types of procedure and manufacturable in a wide variety of forms suitable for many different applications.

WO 96/22797 discloses a tissue-bonding material comprising an aqueous albumin solution and a chromophore such as methylene blue. The material can be used to bond together tissues, eg the opposing edges of two blood vessels that are to be joined, by application of the material to one or both of those edges, followed by the bringing together of the tissues that are to be joined, and application of light energy to bring about cross-linking of the albumin to itself and to the tissues, thereby creating a bond. The methylene blue serves to facilitate the absorption of the light energy and also prevents excessive absorption of energy by undergoing a reversible colour change that stops energy being absorbed as well as signalling to the user that curing has been effected.

Our co-pending International patent application PCT/GB99/02717 discloses albumin-based sheets, which can be applied topically and caused to crosslink and bond to the underlying tissue. Though capable to a limited extent of being formed by the user into, for instance, tubes or rolls, such sheets are essentially two-dimensional structures and are therefore limited in their range of applications. Typically, such sheets are useful only as patches or the like applied to the external surface of a vessel such as an artery, eg to cover and close a puncture in that vessel. Even in these applications, however, the sheets may be of limited utility because in practice the degree of bonding between the sheet and the arterial tissue may be insufficient to withstand the associated pressures.

The implantation of devices within the body is commonplace in surgical procedures. Many such devices are known, and they are often manufactured from metallic or synthetic polymeric materials. A problem that may be encountered with such devices is that they can become dislodged from the site of application, leading to a failure of the device to perform its intended function, or more seriously to complications requiring further surgical intervention. Such problems may be addressed by attempting to fix the device securely in position, eg by the use of sutures or other forms of mechanical fastener, but this is often difficult to achieve.

We have now surprisingly found that tissue bonding material of the type known for use in liquid or planar sheet form can also be used to create pre-formed three-dimensional structures of use in the manufacture and use of implantable devices, and that such structures overcome or substantially mitigate the above-mentioned or other disadvantages of the prior art.

According to a first aspect of the invention, there is provided a pre-formed three-dimensional article, comprising at least in part a material which is hydratable and capable of bonding to tissue whilst retaining its integrity.

The article according to the invention is advantageous primarily in that it can be pre-formed in any of a range of shapes and forms appropriate to its intended application. Because the material from which the article is formed is capable of bonding to the surrounding tissue, the article can be securely anchored within that tissue, with reduced danger of the article becoming dislodged.

The article according to the invention may be attached to the surrounding tissue by one or more of a variety of methods. The material may be activated, eg by irradiation with light as described in more detail below, leading to cross-linking of the material (curing) and the formation of chemical bonds between the material and the tissue. Alternatively, the material may be inherently self-adhesive. In a further alternative, or for additional security in cases where it is possible to do so, the article may be secured by suturing. Combinations of some or all of these attachment methods may also be used.

The articles can be manufactured in such a way that they are either expansible or non-expansible. They can be constructed in such a way as to be permanent, so that they retain their integrity and remain in place for an indefinite period. Alternatively, the articles can be manufactured in such a way as to be partially or wholly biodegradable so that they function for long enough to fulfil their intended purpose but then disintegrate.

The articles according to the invention may have a continuous or open structure. A continuous structure may be favoured where the article has a barrier function, eg to prevent formation of post-surgical adhesions. An open structure may be used where ingrowth of host tissue is desired, eg in vascular closure or where the article functions as a surgical mesh. The article may be partially biodegradable so that it initially serves as a barrier to tissue growth but then degrades to an open structure that supports tissue ingrowth.

The articles according to the invention may also act as a depot for the short- or long-term, localised or systemic delivery of pharmacologically active compounds (eg drugs for tumour reduction, cell growth inhibitors, antibiotics, anti-ulcer drugs etc), growth factors, bio-active polypeptides, proteins, antibodies or cells (eg fibroblasts, keratinocytes for wound healing and in the treatment of wounds).

The material used in the article according to the invention is preferably entirely tissue-compatible. The material is preferably also non-thrombogenic. The hydratable and activatable material is most commonly a crosslinkable proteinaceous or other peptide material. The material may be selected from natural and synthetic peptides, enzymatically cleaved or shortened variants thereof and crosslinked derivatives thereof, as well as mixtures of any of the above. Included among the peptides are structural proteins and serum proteins. Examples of proteins are albumin, α-globulins, β-globulins, γ-globulins, transthyretin, collagen, elastin and fibronectin and coagulation factors including fibrinogen, fibrin and thrombin. The preferred tissue-compatible material for use in the present invention is a soluble protein that is not part of the clotting cascade, such as albumin. Porcine albumin or porcine pericardium or any other abundant non-thrombogenic protein, ie excluding collagen, may be used. In some cases, genetically or chemically modified versions of these proteins may be used.

The material may also include one or more additional components to modify its physical properties. Such components may be elastomers or plasticisers, examples being polyalcohols such as glycerol, polyvinylalcohol and polyethyleneglycol.

It is particularly preferred that the hydratable tissue-bonding material of which the article is made up should comprise albumin in admixture with one or more other components. Mammalian albumin, especially porcine albumin, is especially preferred. Glycerol is a particularly preferred additional component.

As mentioned above, the article according to the invention may take any of numerous different forms. In certain embodiments, the article incorporates non-planar sheets of material pre-formed into shapes which facilitate the application of the article.

For example, in many surgical procedures it is necessary to make a puncture in the relevant tissue or vessel, eg an artery may be punctured to enable the introduction of a surgical or other device. This gives rise to a need to close such a puncture, and this may not be easy to achieve.

One embodiment of the present invention provides a device and method which address this specific problem. In such an embodiment, the invention provides a device for use in the closure of a surgical puncture, said device comprising a sheet of material which is flexible, hydratable and capable of bonding to tissue whilst retaining its integrity, said sheet being folded or collapsed to a condition such that it can be passed through the puncture into the organ or vessel in which the puncture is formed, and said sheet being adapted to expand within the organ or vessel to an operative condition in which the sheet bears against the internal surface of the organ or vessel.

Related to this aspect of the invention, there is provided a method for the closure of a surgical puncture which method comprises

passing into an organ or vessel in which said puncture is formed via said puncture a sheet comprising a material which is flexible, hydratable and capable of bonding to tissue whilst retaining its integrity, said sheet being in a folded or collapsed condition,

causing or allowing the sheet of material to expand within the organ or vessel to an operative condition,

drawing the sheet of material against the internal surface of the organ or vessel, and

causing or allowing the sheet of material to bond to the internal surface of the organ or vessel.

In the folded or collapsed condition the sheet will generally have a configuration which permits the sheet to be passed through the surgical puncture. The sheet may, for instance, have an elongated, ovoid or rectangular shape and be folded about the lateral axis of the sheet. In another embodiment, the sheet may be generally circular and may be folded in the manner of a filter paper or the like, ie a fluted configuration such as that of a collapsed or partially collapsed umbrella.

To facilitate manipulation of the sheet of material it may be attached to a stem or rod, most preferably of a biocompatible material. The stem or rod is most preferably of a solid proteinaceous material, eg it may be albumin-based.

Opening of the sheet of material from the collapsed to the operative condition may be brought about using a suitable applicator device. Such a device may incorporate a hollow tube within which the sheet is accommodated when in the collapsed condition and from which it can be expelled.

The applicator device may also be used to bring about curing of the expanded sheet. The hollow tube, for example, may incorporate means for illuminating the sheet so as to transmit light energy to it.

Particularly where, as will commonly be the case, the tissue in which the puncture is formed has a substantial thickness, it may be necessary or desirable for a second sheet of material to be applied to the external surface of the tissue. Such a second sheet may have an opening by which it is mounted about the rod or stem attached to the first sheet. Again, the second sheet may be delivered using the applicator device, which is also preferably used, as for the first sheet, to initiate curing of the second sheet.

It may also be necessary or desirable for the puncture, between application of the first and second sheets, to be filled or plugged with biocompatible material, eg of collagen, fibrin or other proteinaceous material.

Another area in which the invention may be useful is surgical procedures involving the implantation of devices into blood vessels. Very often such devices are designed such that they are caused to expand from a collapsed condition, which facilitates insertion of the device, to an expanded, operative condition. Examples of such devices are cardiac stents and cardiac support devices.

Devices of this kind suffer from the disadvantage that they may damage the internal surfaces of the vessels through which they are inserted. In addition, the device may be displaced from the site at which it is installed, with potentially very serious consequences for the patient.

This invention addresses these problems by providing a three-dimensional pre-formed structure formed of sheet material, the sheet material being suitable for therapeutic use by topical application, the sheet material being flexible, hydratable, capable of bonding to tissue, and retaining its integrity on bonding, the sheet material being coiled helically to the form of an expansible roll.

The invention further provides an implantable device surrounded by a pre-formed structure formed of sheet material as defined in the preceding paragraph.

The pre-formed structure of this embodiment of the invention surrounds the implantable device and then expands with the implantable device, providing a protective barrier between the device and the internal walls of the vessel into which the device is implanted. The sheet may also enhance anchorage of the device at its intended site and may inhibit restenosis.

For the applications described above, involving structures formed from sheet materials, the sheet of material may be 20-1000 μm in thickness, and typically approximately 100-500 μm in thickness.

In such applications, the sheet may comprise a single layer of material. Alternatively, especially where a thin layer is used and/or the material has insufficient integrity for the desired purpose, a carrier layer may be laminated with the sheet. Suitable materials for the carrier layer are biocompatible materials, eg polybutyrate, polysaccharides, polytetrafluoroethylene, polyesters, glycoproteins, polymer composites, collagen (including cross-linked collagen), pericardium, ethacrylate, polyurethane and derivatives thereof. Other materials include absorbable and non-absorbable suture materials, eg polypropylene, polyglactin, polyglycolic acid, polydioxanone and polyglyconate.

Another class of structures according to the invention are three-dimensional structures formed by processes such as moulding.

A first form of such structure is a tubular structure. Such structures may, for instance, be used as stents for the internal support of vessels such as blood vessels. Such stents may be produced with diameters to suit the intended application, eg in a range of standard diameters. Such tubular structures may also be manufactured with any desired length, or may be manufactured with oversize lengths, being cut to an appropriate size by the user immediately prior to use. Alternatively, more than one such stent may be implanted adjacent to one another so as to create an overall implant of elongated form.

Typical dimensions for tubular structures of this kind are a diameter of from 3 mm to 20 mm, most commonly 6 mm to 10 mm, and a length of 5 mm to 600 mm, most usually 10 mm to 300 mm.

In a variation on this form of structure, stent components of part-circular cross-section may be formed, which in combination make up a tubular structure. Such structures may be applied to vessels either internally or externally

The invention may also provide structures of relatively simple form, such as solid plugs that may be used to seal or fill cavities and holes. Such plugs may be formed with any suitable shape, eg generally cylindrical, ellipsoidal or cuboidal plugs. Such plugs may be solid or may be porous or sponge-like. They may be essentially rigid, or deformable or flexible.

Another simple form of three-dimensional structure is a solid cylindrical filament that may be used for securing other devices in place, in the manner of a suture.

Structures having more complex shapes may also be produced, particularly by moulding techniques. Examples include pre-formed connectors, eg for the end-to-end or end-to-side anastomotic apposition and closure of vessels, fasteners such as staples or barbed pins for holding tissues together, or fixing plugs to be fitted, for example, into holes in bone to provide anchorages for mechanical fasteners such as screws,or for example dental crowns.

Surgical meshes may also be manufactured using the tissue-bonding material. Such meshes may be moulded as integral articles or may be fabricated from filamentous material by weaving or the like.

Another important class of structures are those intended to serve as scaffolds for tissue regeneration. Such scaffolds may be prepared with any suitable shape, corresponding to the desired shape of the tissue to be regenerated. Structures for this type of application will generally be of open structure to allow for tissue ingrowth. Such structures may appear to be continuous, being porous only on a microscopic scale, or may be mesh-like, being evidently open and only a minor proportion of the overall volume of the structure being occupied by solid material.

For some applications, in order to improve adhesion, the surfaces of the article according to the invention which, in use, are brought into contact with tissues may be coated with a layer of fluid tissue bonding material. Such a coating may take the form of a liquid or low viscosity gel, most preferably comprising the tissue-compatible bonding material in water. A certain degree of viscosity may be desirable. Viscosity-modifying components may therefore be incorporated into the composition, such as hyaluronic acid and salts thereof such as sodium hyaluronate, hydroxypropylmethylcellulose, glycerine, dextrans, honey, sodium chondroitin sulphate and mixtures thereof.

In an alternative approach intended to improve the adhesive properties of the article, the article may comprise a matrix of not only the material having tissue bonding properties but also a synthetic polymer having bioadhesive properties.

The bioadhesive polymer component of the matrix may be any polymer with suitable bioadhesive properties, ie any polymer that confers on the matrix a sufficient degree of adhesion to the tissue to which it is applied. Preferred groups of such polymers are polycarboxylic acid derivatives, a particularly preferred class of such polymers being copolymers of methyl vinyl ether and maleic anhydride, in the form of the anhydride, ester, acid or metal salt. Such polymers are supplied by International Specialty Products under the trade mark GANTREZ®.

The matrix preferably further comprises a plasticiser in order to ensure that the matrix has sufficient flexibility, even after polymerisation or cross-linking. Suitable plasticisers include polyalcohols, eg glycerol, sorbitol etc.

The matrix preferably also comprises a synthetic structural polymer to confer strength and elasticity on the matrix. Suitable such polymers include water-soluble thermoplastic polymers, in particular selected from the group consisting of poly(vinyl alcohol), poly(ethylene glycol), poly(vinyl pyrrolidone), poly(acrylic acid), poly(acrylamide) and similar materials.

A relatively small proportion of surfactant, most preferably a non-ionic surfactant, will generally be incorporated into the matrix, though normally to facilitate manufacture (prevention of foaming etc) rather than to confer any beneficial property on the finished product. Suitable surfactants include block copolymers of ethylene oxide and propylene oxide, such as those sold under the trade marks Pluronic® by BASF.

The matrix may be homogeneous or heterogeneous in composition, and may be of continuous or discontinuous structure. All or just some of the surface of the article may have adhesive properties.

The matrix most preferably comprises the following proportions of the individual components:

a) cross-linkable material—from about 2% to 80% by weight, more preferably 10% to 60%, and most preferably 30% to 50%;

b) structural polymer—from about 0.01% to 20% by weight, more preferably 1% to 15%, and most preferably 2% to 10%;

c) surfactant—from about 0.001% to 10% more preferably 0.01% to 5%, and most preferably 0.05% to 1%;

d) plasticiser—from about 0.01% to 50%, more preferably 10% to 40%, and most preferably 20% to 40%;

e) bioadhesive polymer—from about 0.01% to 50% by weight, more preferably 1% to 40%, and most preferably 5% to 3C%.

The matrix may be manufactured by combining solutions of the different components as follows (all amounts are percentage weight of the component in the respective solution prior to combination):

a) Solution A:

i) cross-linkable material: 5-60%, more preferably 10-40%, and most preferably 20 to 30%.

ii) structural polymer: 0.01-20%, more preferably 1-10%, and most preferably 2-8%.

iii) surfactant: 0.001-10%, more preferably 0.01-5%, and most preferably 0.1-1%.

iv) plasticiser: 0.01-60%, more preferably 1-50%, and most preferably 10-40%

b) Solution B:

i) bioadhesive polymer: 0.01-40%, more preferably 0.1-30%, and most preferably 1-20%.

ii) plasticiser: 0.01-40%, more preferably 0.1-30%, and most preferably 1-20%

In a preferred embodiment of a sheet-like structure, where one surface only, or a selected part thereof, is bioadhesive, the matrix may be prepared by casting Solution A into a suitable non-stick mould (e.g. of PTFE), and allowing it to set through evaporation. Onto this is then cast Solution B, which is also allowed to set. During this process, the second solution penetrates into, and chemically binds to, the matrix formed by the first solution, so that the final matrix is composed of a single sheet with concentration gradients of the various components. In such a case, it will be the surface of the sheet that, in use, is brought into contact with the internal surface of the organ or vessel containing the puncture which is bioadhesive.

Alternatively, the matrix may be prepared from a single solution comprising all the components, or by combination of multiple solutions to create multi-lamellar matrices (e.g. bioadhesive—polymeric matrix—bioadhesive).

The casting process used to achieve the desired thickness of sheet may involve pouring, manual spreading or spraying of the component solutions.

The matrix will typically contain between 5% and 60% water by weight, and most preferably between 10% and 40%. The matrix may be partially or totally hydrated with a suitable aqueous medium at or following application (eg a body fluid or saline solution).

For some uses, it may be desirable to modify the stability of the article according to the invention—such that the half-life of the product is extended (for use in reinforcement of weakened tissue) or reduced (for drug release). This modification of stability can be effected by controlling the extent of formation of covalent bonds between molecules in the matrix (e.g. formation of disulphide bonds between protein molecules). If an increase in patch stability is desired, the matrix can be pre-treated to induce the formation of intermolecular covalent bonds.

Pre-treatment methods that can be used to modify the stability of the matrix are:

1) Heat: Temperatures from 30-70° C. will promote an unravelling of the polypeptide chains, which may reduce water solubility of the protein. Exposure of the matrix to temperatures between 70° C. and 120° C. will promote formation of covalent bonds between albumin molecules. This will increase the stability of the article, the degree of stability achieved being dependent on the precise time, and temperature of this pre-treatment.

2) Irradiation: Electromagnetic radiation (including visible and UV light, and gamma irradiation) can promote cross-linking of albumin molecules. This is a potential method by which large articles could be pre-treated in such a way as to increase their stability.

3) Chemical: There are a large variety of chemical cross-linking reagents which could potentially be used to induce formation of covalent bonds within the matrix, including chromophore dyes such as methylene blue.

The article according to the invention or the coating (if any) of tissue bonding material applied to it may, or may not, contain a thermochromic compound (which undergoes a colour change on the application of heat) and/or a photochromic compound (which undergoes a colour change on the application of light). For example, the material may include a chromophore, such as methylene blue, which will change colour when the end point (when light activated) has been reached, as described in WO 96/22797. Such a visual colour change may provide the user with an indication that sufficient energy has been applied to ensure that curing of the tissue bonding material has occurred. In addition, when curing is complete the resultant colour change ensures that the material will absorb no further radiant energy. This provides protection against excess energy input.

If a light activated chromophore is present it provides the user, ie normally a surgeon or veterinary surgeon, with means to determine whether or not adequate energy has been provided in the desired area.

As an alternative to heat or light, curing may be brought about using a chemical activator such as a crosslinking agent, eg hexamethylenediisocyanate, which may be applied by spraying or wetting.

In some circumstances the tissue bonding material may cure spontaneously. However, it is generally preferred that curing be brought about by the application of heat or, most preferably, light.

Articles in accordance with the invention may be manufactured by various methods. A-wide range of articles may be manufactured by moulding techniques, eg injection moulding using a non-cross-linked liquid, which is then cross-linked in the mould, by the application of heat or radiation. Articles in the form of solid filaments, foams and sponges may be prepared by extrusion. Such filaments may be woven or knitted into planar meshes or three-dimensional mesh shapes. Solid patches, films, foams and sponges may also be prepared by techniques such as screen printing, casting, dip-coating, injection moulding and extrusion, casting etc.

As well as methods leading to integral articles, three-dimensional articles may be fabricated from smaller components. For example, structures may be built up from sheets and/or filaments impregnated with or surrounded by liquid bonding material. Three-dimensional structures may also be built up sequentially, eg by selective curing of a bath of cross-linkable material (cf stereolithography) or by the stepwise application and curing of layers of cross-linkable material in gel form.

Articles according to the invention will generally be manufactured in the desired form and supplied as single-use, sterile devices. However, it may alternatively be possible in certain applications for the article to be constructed by the user prior to implantation. Such a case might be applicable, for instance, to scaffolds for tissue repair. In such a case, the materials supplied might include material for forming an impression of the shape to be constructed, moulding material and the material needed for formation of the final device.

The invention will now be described in greater detail, by way of illustration only, with reference to the accompanying drawings and Examples, in which

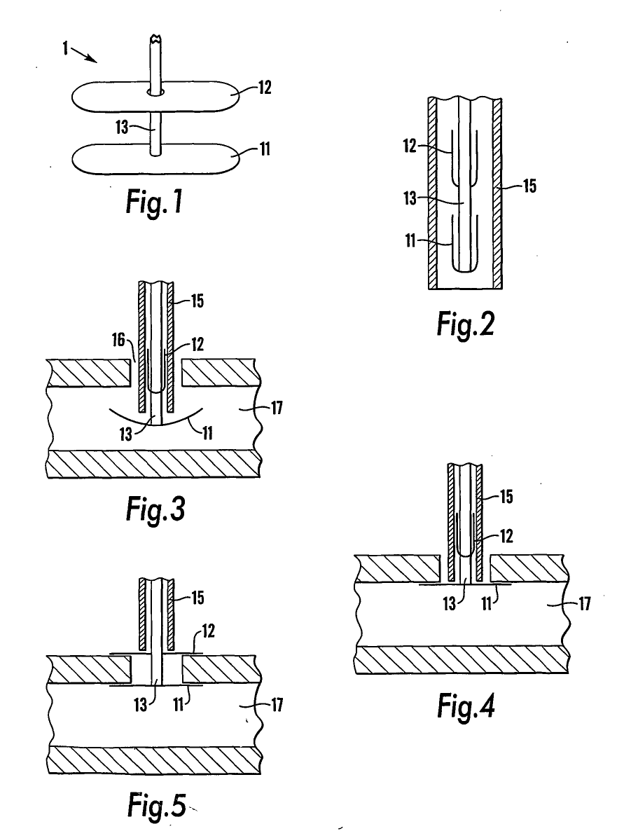

FIG. 1 shows components of a first embodiment of an article according to the invention, in the form of a device for the closure of a surgical puncture;

FIG. 2 shows a tip of an applicator used for applying the device of FIG. 1;

FIGS. 3 to 5 show stages in the application of the device of FIG. 1 using the applicator of FIG. 2;

FIG. 6 is a cut-away view of a vessel to which the device of FIG. 1 has been applied;

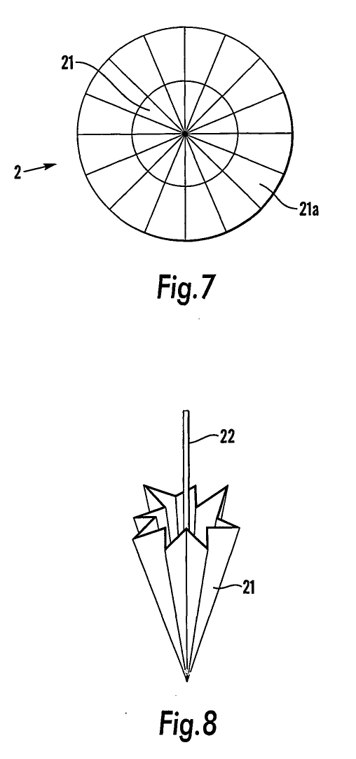

FIG. 7 is a plan view of a circular sheet of proteinaceous material forming part of a second embodiment of a device for the closure of a surgical puncture;

FIG. 8 shows the device of FIG. 7 in a collapsed condition;

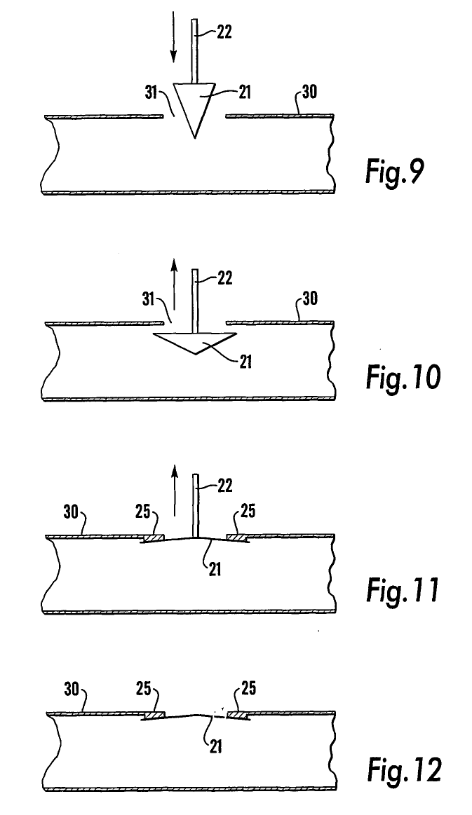

FIGS. 9 to 12 show in schematic form stages in the use of the device of FIGS. 7 and 8 in the closure of a surgical puncture;

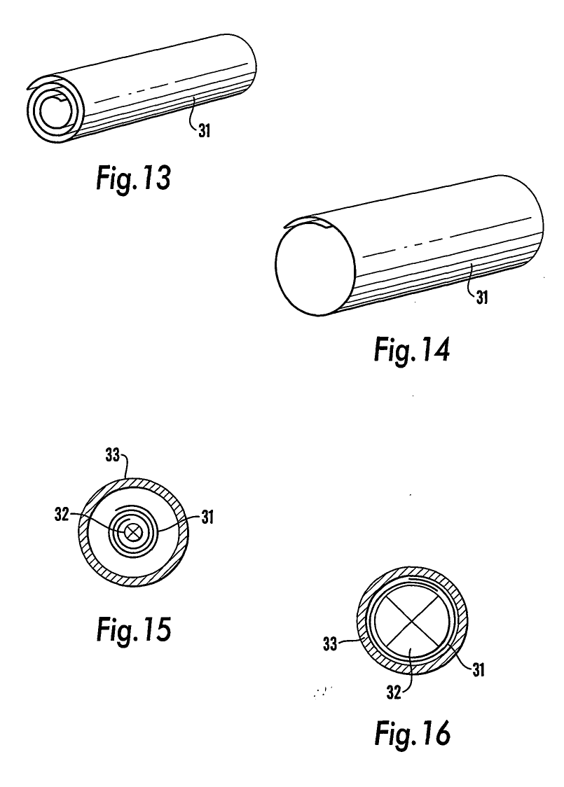

FIG. 13 is a perspective view of a further embodiment of the invention, in the form of a coiled sheet;

FIG. 14 shows the sheet of FIG. 13 in an expanded condition;

FIG. 15 is a cross-sectional view of a blood vessel into which an implantable device surrounded by the sheet of FIG. 13 has been introduced;

FIG. 16 is a view similar to FIG. 15 of the device shown in FIG. 15 expanded into an operative condition;

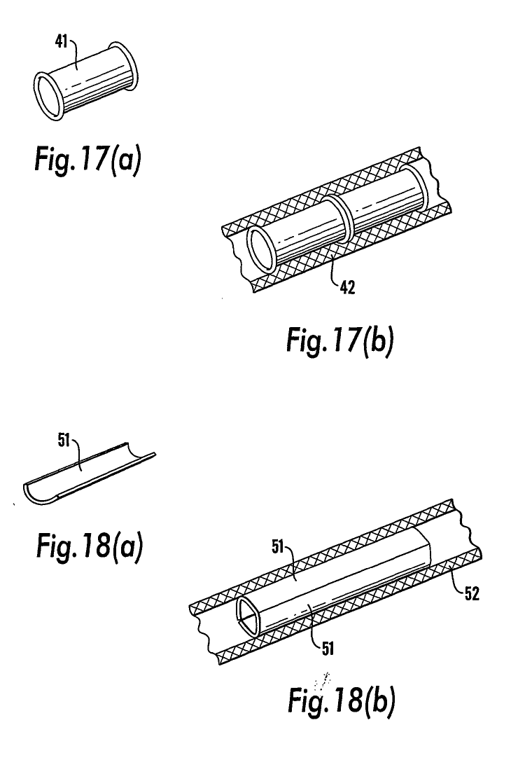

FIG. 17(a) shows a perspective view of a further embodiment of the invention in the form of a cylindrical stent, and FIG. 17(b) is a schematic view of a pair of such stents implanted in an artery;

FIG. 18(a) is a perspective view of a hemi-cylindrical stent element according to the invention, and FIG. 18(b) shows schematically a pair of such elements implanted in an artery;

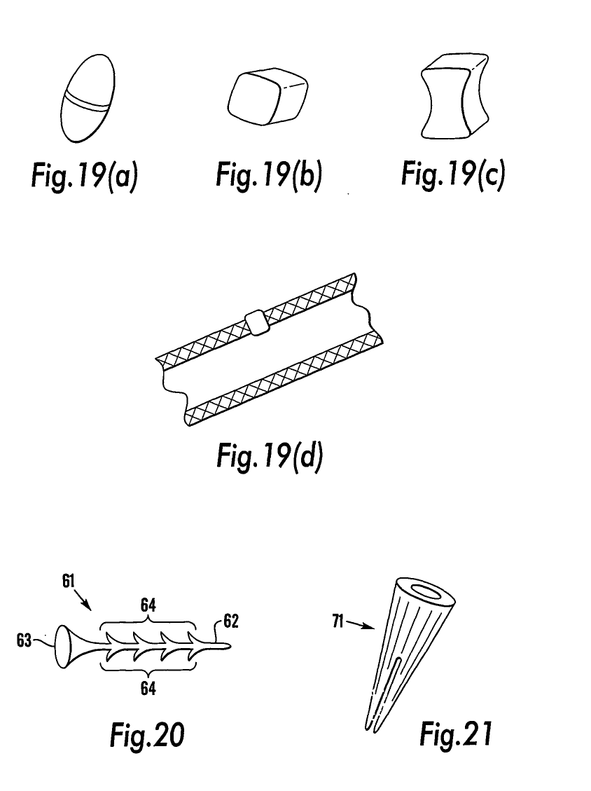

FIGS. 19(a),(b) and (c) show solid plugs according to the invention, and FIG. 19(d) shows the manner in which such a plug can be used to close a puncture in a vessel such as an artery;

FIG. 20 is a perspective view of a barbed pin according to the invention;

FIG. 21 is a perspective view of a fixing plug according to the invention;

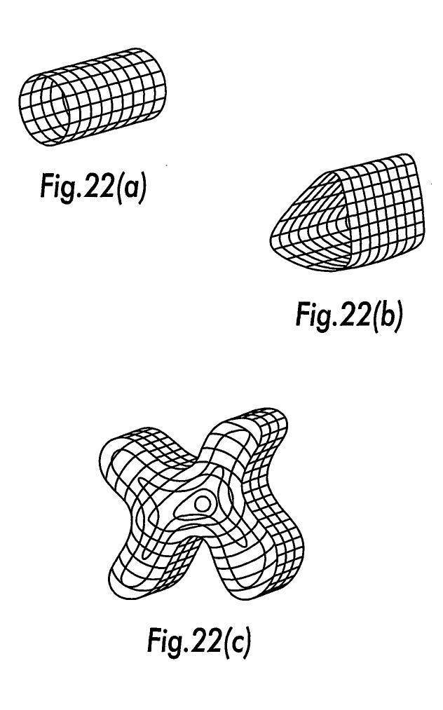

FIGS. 22(a),(b) and (c) show perspective views of exemplary tissue regeneration scaffolds according to the invention;

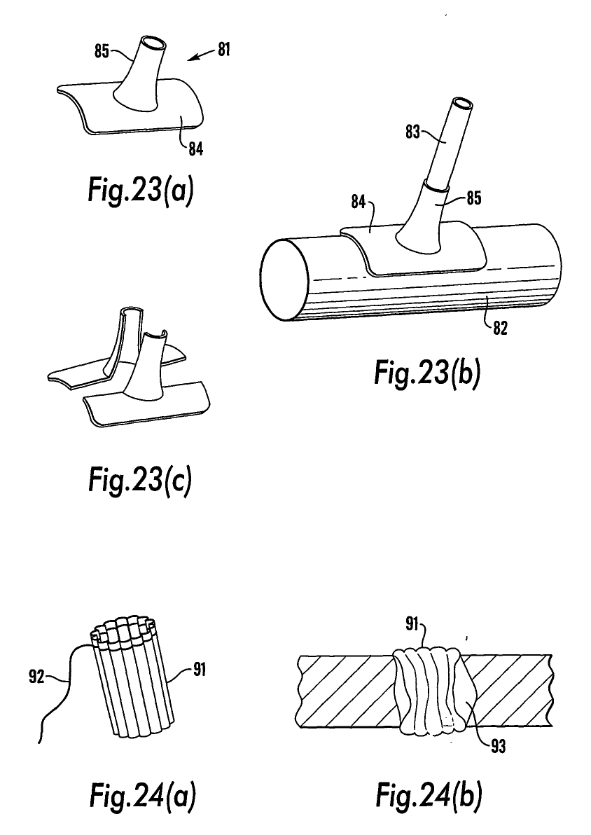

FIG. 23(a) is a perspective view of a T-piece connector used to form a side-to-end anastomosis, as shown in FIG. 23(b), and FIG. 23(c) shows another form of such a T-piece connector; and

FIG. 24(a) shows schematically a pleated tape which can be expanded within a tissue cavity, so as to fill the cavity as shown in FIG. 24(b).

Referring first to FIG. 1, a first embodiment of the invention takes the form of a device 1 for use in the closure of a surgical puncture, and comprises first and second sheets 11,12 of tissue bonding material. The first sheet 11 is fixed to one end of a solid stalk 13 of albumin-based material, the second sheet 12 having a central opening and being mounted freely about the stalk 13. The sheets 11,12 are cut from a sheet prepared by the method of one of the Examples given below.

An applicator for use in applying the device 1 of FIG. 1 to a surgical puncture is illustrated schematically in FIG. 2, and the manner in which the device 1 is so applied is shown schematically in FIGS. 3 to 5.

The applicator comprises a hollow tip 15 within which the device 1 is stored. In this condition, the sheets 11,12 are folded upwards in U-shaped configurations and spaced apart. The hollow tip 15 serves, in use, as a light guide for the application of light from a light source (not shown) to the sheets 11,12 so as to activate the sheets 11,12 and promote bonding of the sheets 11,12 to adjacent tissue, as described below.

Stages in the closure of a surgical puncture are illustrated in FIGS. 3 to 5, which show a puncture 16 in a vessel 17 such as an artery. First, the tip 15 is introduced through the puncture 16 and the device 1 displaced from the tip 15 sufficiently for the first sheet 11 to emerge from the end of the tip 15. Once freed from the tip 15, the first sheet 11 unfolds, as shown in FIG. 3.

The tip 15 is then withdrawn through the puncture 16 sufficiently to bring the first sheet 11 into contact with the internal surface of the vessel 17 (FIG. 4). Light is applied to the first sheet 11 via the tip 15 so as to activate the first sheet 11 and cause it to bond to the internal surface of the vessel 17.

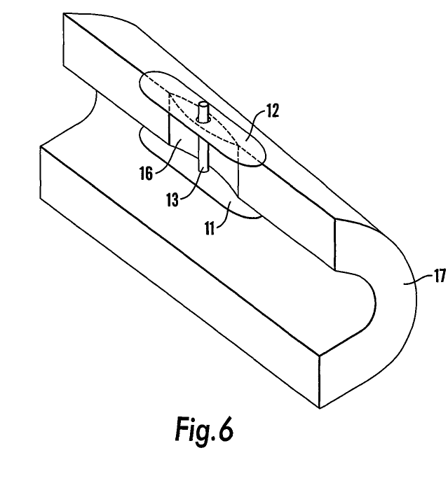

Following further withdrawal of the tip 15 from the puncture 16, the second sheet 12 is released from the tip 15 and can then be pressed by the tip 15 into engagement with the external surface of the vessel 17 (FIG. 5). Again, light is applied via the tip 15 to the second sheet 12 to cause it to bond to the underlying tissue.

The tip 15 is retracted again and closure of the puncture 16 is completed by cutting through the stalk 13 close to the second sheet 12. The completed closure is shown in cut-away form in FIG. 6.

It may be necessary or desirable for the puncture 16 to be further closed by a plug of suitable material which may be introduced after the first sheet has been bonded to the internal surface of the vessel 17. Such material may be a curable material introduced in liquid or gel form, or may be in the form of a solid or semi-solid plug which is mounted on the stalk 13, between the first and second sheets 11,12.

Referring now to FIGS. 7 to 12, a second embodiment 2 of a device according to the invention comprises a fluted circular sheet 21 of tissue bonding material to which is attached an elongate stalk 22 of solid, albumin-based material. The sheet 21 is cut from larger sheets of material prepared by the method of one of the Examples given below.

The sheet 21 is folded on the lines indicated in FIG. 7 so that, after the stalk 22 has been attached to the centre of the sheet 21, it can be folded into the fluted configuration shown in FIG. 8. Prior to folding in this manner, if the sheet 21 is of material that is not inherently adhesive the outer portion 21a of the surface of the sheet 21 which, when folded into the fluted configuration, is the internal surface may be coated with a viscous albumin-containing gel having the following composition:

| | |
|---|---|
| Porcine albumin | 41% w/w |
| Methylene blue | 0.24% w/w |
| Glycerol | 2% w/w |
| Water for injection | q.s. |

The composition was made up by dissolving/dispersing the albumin, methylene blue and glycerol in the water for injection.

The manner in which the device 2 is used is illustrated schematically in FIGS. 9 to 12. Referring first to FIG. 9, a vessel 30 has a puncture 31 which was formed to permit a surgical procedure and which must be closed after completion of that procedure. The vessel 30 is clamped to prevent flow of blood through the vessel 30.

The device 2 is inserted, in the collapsed condition, through the puncture 31 in the direction of the arrow in FIG. 9. In the collapsed condition the overall dimensions of the fluted sheet 21 are small enough for it to pass through the puncture 31.

Once the sheet 21 is fully inserted into the vessel 30 it is drawn back by means of the stalk 22 in the direction of the arrow in FIG. 10. As the device 2 is so withdrawn, the sheet 21 opens within the vessel 30 until it comes into contact with the internal surface of the vessel 30 around the periphery of the puncture 31 (see FIG. 11).

Application of light of suitable intensity to the sheet 21 around the peripheral regions of the puncture 31 activates the adhesive applied to the surface of the sheet 21 and brings about the formation of bonds 25 between the sheet 21 and the tissue of the vessel 30. On completion of curing the colour changes from blue to colourless, indicating that sufficient energy has been applied.

Finally, the stalk 22 is snipped off (FIG. 12) and the vessel 30 is unclamped to allow blood to flow through it once more.

Examples of the methods by which sheets of material can be prepared are as follows:

### EXAMPLE 1

0.9 g porcine albumin (Sigma) was dissolved in 2.5 ml water for injection (Phoenix Pharmaceuticals pH 7.7) and 0.5 ml of 1% w/v methylene blue for injection. To this solution, 0.585 g D-sorbitol was added and dissolved. Heating of this solution in a thermostatted water bath at 59° C. increases the film rehydration time from 50 seconds (if left at room temperature) to 140 seconds. This solution was left to cool for 30 minutes and then cast on a level PTFE-coated surface. The film was left to dry at room temperature for 20 hours.

### EXAMPLE 2

2.84 g of porcine albumin was dissolved in 9 g of water for injection (Huddersfield Royal Infirmary) with 1.625 g of glycerol. This solution was then used to cast sheets on a dacron (polyester) membrane. The sheet was then heated to 120° C. for 10 minutes to partially crosslink the protein molecules within the sheet. This method of manufacture provided a strong sheet that was found to be insoluble in water. This method may therefore be suitable for the manufacture of sheets where long-term stability is important.

### EXAMPLE 3

1.15 ml of a 30% (wAN) porcine albumin solution was added to 0.2 ml of glycerol and 0.125 ml of polyethyleneglycol 400. This solution was used to cast sheets on a dacron (polyester) membrane. The sheets were then heated to 70° C. for 30 minutes in a moist environment. Sheets prepared in this way were flexible and stretchable. These sheets may be particularly suitable for a variety of purposes.

### EXAMPLE 4

1.25 ml of a 30% (w/w) porcine serum albumin solution was added to 0.2 ml of glycerol. This solution was used to cast sheets on a dycem non-slip membrane. The sheets were allowed to dry overnight at room temperature. The sheets were then irradiated with 3000 J/cm³ ultraviolet radiation for 20 minutes. This produced a strong, stretchable sheet that was crosslinked in such a way that it would remain intact in vivo for an extended period of time.

### EXAMPLE 5

1.51 g of porcine albumin, 0.1 g of 80% hydrolysed polyvinyl alcohol, 1.42 g of glycerol and 0.01 g of Pluronic 25R2 were dissolved in 2.02 g of water for injection. 0.1 ml of this solution was poured onto a level PTFE surface, and spread to a thickness of approximately 50 μm. The solution was heated to 120° C. for 10 minutes to evaporate off water and allowed to cool.

A second solution was prepared containing 5.09 g of Gantrez MS-955 and 8.5 g of glycerol in 36.5 g of water for injection. 0.1 ml of the second solution was similarly cast on top the cooled matrix, again to a thickness of approximately 50 μm. The matrix was heated at 120° C. for a further 10 minutes, and allowed to cool.

### EXAMPLE 6

3.03 g of porcine albumin, 0.5 g of 80% hydrolysed polyvinyl alcohol, 3.00 g of glycerol and 0.02 g of Pluronic 25R2 were dissolved in 3.53 g of water for injection. 0.1 ml of this solution was poured onto a level PTFE surface, and spread to approximately 30 μm thick. The matrix was heated at 120° C. for 10 minutes and allowed to cool.

0.1 ml of a second solution (from a stock comprising 5.09 g of Gantrez MS-955 and 8.5 g of glycerol in 36.5 g of water for injection) was cast onto the cooled matrix, again to a thickness of approximately 30 μm. The matrix was heated further at 70° C. for 15 minutes, and allowed to cool.

### EXAMPLE 7

9.00 g of porcine albumin, 1.53 g of 80% hydrolysed polyvinyl alcohol, 8.98 g of glycerol and 0.06 g of Pluronic 25R2 were dissolved in 10.56 g of water for injection. 0.3 ml of this solution was poured onto a level PTFE surface, and spread to a thickness of approximately 50 μm, and left at room temperature for 1 hour.

0.3 ml of a second solution (from a stock comprising 5.09 g of Gantrez MS-955 and 8.5 g of glycerol in 36.5 g of water for injection) was cast on top of the first matrix, again to a thickness of approximately 50 μm. The matrix was left at room temperature for a further 1 hour.

### EXAMPLE 8

1.51 g of porcine albumin, 0.1 g of 80% hydrolysed polyvinyl alcohol, 1.42 g of glycerol and 0.01 g of Pluronic 25R2 were dissolved in 2.02 g of water for injection. 0.1 ml of this solution was poured onto a level PTFE surface, and spread to approximately 60 μm thick. The solution was heated to 120° C. for 10 minutes to evaporate off water and allowed to cool.

0.1 ml of a 30% w/w Gantrez AN-119 BF (the anhydride) solution and 20% whw glycerol, in water for injection, was similarly cast onto the existing matrix, again to a thickness of 60 μm. The product was heated at 70° C. for 15 minutes to evaporate water, and allowed to cool.

In each case, the sheets of material are cut to the desired shape and folded or fluted to form the non-planar structure according to the invention. The sheets prepared in accordance with Examples 1 to 4 may be coated with albumin-containing gel as described above prior to folding; the sheets prepared in accordance with Examples 5 to 8 are inherently self-adhesive.

Turning now to FIGS. 13 to 16, a further embodiment of an article in accordance with the invention takes the form of a coiled sheet 31 which, in use, surrounds an implantable device.

A sheet of material is prepared in accordance with the method outlined in Example 9:

### EXAMPLE 9

0.9 g porcine albumin was dissolved in 3.0 ml water for injection. To this solution 0.585 g sorbitol was added and dissolved. The solution was then heated to 50° C., left to cool for thirty minutes and then cast on a level PTFE-coated surface.

The sheet so formed is cut into rectangles of dimension 50 mm×30 mm.

The individual rectangles are then rolled on a mandrel of diameter 5 mm which is laid transversely to the sheet. Mild thermal treatment may then be sufficient to cause the rolled sheet to retain its coiled configuration. In order to prevent the sheet bonding to itself, a sheet of an inert spacer material may be rolled up with the sheet and subsequently removed.

FIG. 13 shows the configuration of the rolled sheet 31, and the expanded condition, achieved by exerting outward pressure from within, is shown in FIG. 14.

As shown in FIG. 15, the sheet 31 of FIG. 13 can be used as a sheath for an implantable device 32 which is inserted into a blood vessel 33. When the device 32 is expanded in conventional fashion, it applies to the surrounding coiled sheet 31 an outward force which causes the sheet to uncoil and expand to the condition shown in FIG. 16, in which the sheet 31 forms a protective lining to the vessel 33.

The sheet of material may alternatively be prepared in accordance with one of Examples 1 to 8.

Turning now to FIG. 17, this shows a cylindrical stent 41 intended for implantation within a vessel such as an artery 42 (see FIG. 17(b)). The stent 41 is formed by injection-moulding and comprises a hollow cylinder of uniform cross-section with enlarged rims at each end. The enlarged rims serve to facilitate the end-to-end joining of two or more stents 41 to form an elongated tubular structure.

Tubular structures of this kind, and the other injection moulded structures described below, can be produced by processes analogous to that described below in Example 10.

Another form of stent is shown in FIG. 18(b), this time comprising a generally hemi-cylindrical stent element 51. Again, the stent element 51 can be formed by injection moulding, though other techniques such as extrusion could also be used. As shown in FIG. 18(b), two identical stent elements 51 are implanted within an artery 52 to form a completed, generally cylindrical structure. In alternative embodiments, cooperating stent elements may have differing dimensions such that one is received within the other. Such alternatives may offer greater rigidity.

It will be appreciated that the stent element 51 can also be applied to the external surface of a vessel such as the artery 52, eg to close an opening in the artery wall. In such a case, it may be beneficial for the concave, inner surface of the stent element 51 to be adhesive, either through being inherently self-adhesive or by virtue of having fluid tissue-bonding material applied to it prior to implantation.

FIG. 19 shows simple plugs of solid material according to the invention which are intended for the closure of cavities or holes in tissue. Such plugs may have any suitable shape, the examples illustrated being ellipsoidal (a), cuboid (b) and concave-sided (c). The manner in which a puncture in the wall of an artery may be plugged using an article of this type is illustrated schematically in FIG. 19(d).

It will be appreciated that different articles according to the invention may be used in combination. For example, a puncture in an artery wall may be plugged using a plug as illustrated in FIG. 19 and then a hemi-cylindrical element as shown in FIG. 18(a) may be applied to the external surface of the artery. Similarly, a plug of similar form to those illustrated in FIG. 19 may be incorporated in devices similar to that illustrated in FIGS. 1 to 6, as mentioned above in relation to that embodiment.

An injection-moulded barbed pin 61 is shown in FIG. 20. This has a shaft 62 and an enlarged head 63. Barbs 64 are spaced at intervals along the shaft 62. The pin can be used in a manner similar to known pins of like construction, to hold together apposing tissues through which the pin 61 is driven, thereby captivating the tissues between the enlarged head 63 and the barbs 64.

The fixing plug 71 shown in FIG. 21 is similar in form to the familiar wall plug used for fixing screws into masonry. The plug 71 is formed by injection moulding and is intended to be inserted into a hole in a bone or the like. The plug 71 then provides an anchorage for a surgical screw, or for a dental crown.

The mesh structures shown in FIG. 22 are intended to serve as scaffolds for tissue regeneration or tissue engineering. Such structures may be formed by a variety of methods including moulding. The examples shown are tubular (a), wedge-shaped (b) and a complex multi-lobe structure (c), but a variety of different shapes are possible.

FIG. 23 shows a “T-piece” type connector 81 by which an anastomosis may be created between two vessels, eg a larger artery 82 and a smaller diameter artery 83. The connector 81 comprises a flexible flange 84 adapted for application to the surface of the larger artery 82, and a tubular socket 85 upstanding therefrom. In use, the flange 84 is adhered to the larger artery 82, about a point at which a puncture exists, or has been formed in, that artery, and the socket 85 receives the end of the smaller artery 85. The connector 81 can then be bonded to both arteries, thereby forming a joint between them. Alternatively, the T-piece may be supplied in at least two parts (see FIG. 23(c)) which are joined together in situ, by application of energy, or through being inherently self-adhesive.

The connector 81 of FIGS. 24(a) and 24(b) may be produced by the process of Example 10:

### EXAMPLE 10

0.9 g of porcine albumin was dissolved slowly in 1 ml of distilled water. Into this, 0.585 g of D-sorbitol was dissolved. The resulting solution was left to settle for 12 hours, prior to discarding a top layer of foam. Methylene blue powder (2 mg) was dissolved into the remaining solution. The resulting blue viscous solution was injected into a 3-piece silicone rubber mould (two equivalent female halves and a center male mandrel for the lumen), into which the T-piece shape had been cut. The mould with the solution in place was then heated at 61° C. for 20 minutes in an oven, to partially cross-link the protein component. The mould was then left to cool at room temperature for 2 hours, after which time the two outer halves of the mould were removed. The T-piece, supported now by the male mandrel only was then left at room temperature for a further 10 hours to complete the drying process. After this time the centre male mandrel was removed, leaving the completed T-piece device.

Finally, FIG. 24 shows a further device fabricated from sheet-like material. In this case, the sheet material (prepared, for instance, in accordance with one of the Examples 1 to 9 given above) is gathered up into a pleated roll 91. A drawstring 92 is passed through the roll 91 in such a manner that withdrawal of the drawstring 92 causes the roll 91 to expand. Thus, the roll 91 can be inserted into a cavity 93 and expanded so as to loosely fill that cavity as shown in FIG. 24(b).

1. A pre-formed three-dimensional article, comprising at least in part a material which is hydratable and capable of bonding to tissue whilst retaining its integrity, which material may be activated, leading to cross-linking of the material and the formation of chemical bonds between the material and tissue to which it is applied, and/or which material is inherently self-adhesive.

2. An article as claimed in any preceding claim, wherein the article has a continuous structure and performs a barrier function.

3. An article as claimed in claim 1, wherein the article has an open structure to permit tissue ingrowth.

4. An article as claimed in any preceding claim, wherein the article is biodegradable.

5. An article as claimed in any preceding claim, which serves as a depot for the delivery of pharmacologically active compounds.

6. An article as claimed in any preceding claim, wherein the hydratable material is a crosslinkable proteinaceous or other peptide material.

7. An article as claimed in claim 6, wherein the material comprises albumin.

8. An article as claimed in claim 7, wherein the albumin is mammalian albumin, especially porcine albumin.

9. An article as claimed in claim 6 or claim 7, comprising albumin in admixture with one or more additional components.

10. An article as claimed in claim 9, which comprises glycerol.

11. An article as claimed in any preceding claim, wherein the article comprises a sheet of material pre-formed into a non-planar shape.

12. An article as claimed in claim 11, in the form of a device for use in the closure of a surgical puncture, said device comprising a sheet of material which is flexible, hydratable and capable of bonding to tissue whilst retaining its integrity, said sheet being folded or collapsed to a condition such that it can be passed through the puncture into the organ or vessel in which the puncture is formed, and said sheet being adapted to expand within the organ or vessel to an operative condition in which the sheet bears against the internal surface of the organ or vessel.

13. A method for the closure of a surgical puncture, which method comprises
passing into an organ or vessel in which said puncture is formed via said puncture a sheet comprising a material which is flexible, hydratable and capable of bonding to tissue whilst retaining its integrity, said sheet being in a folded or collapsed condition,
causing or allowing the sheet of material to expand within the organ or vessel to an operative condition,
drawing the sheet of material against the internal surface of the organ or vessel, and
causing or allowing the sheet of material to bond to the internal surface of the organ or vessel.

14. An article as claimed in claim 12, wherein the sheet has an elongated, ovoid or rectangular shape and is folded about the lateral axis of the sheet.

15. An article as claimed in claim 12, wherein the sheet is generally circular and is folded in a fluted configuration.

16. An article as claimed in claim 12, wherein the sheet is attached to a stem or rod of a biocompatible material.

17. An article as claimed in claim 16, wherein the stem or rod is of a solid proteinaceous material.

18. An article as claimed in claim 12 in combination with an applicator device incorporating a hollow tube within which the sheet is accommodated when in the collapsed condition and from which it can be expelled.

19. An article as claimed in claim 12, further comprising a second sheet of material applied, in use, to the external surface of the tissue.

20. An article as claimed in claim 16 and claim 19, wherein the second sheet of material has an opening by which it is mounted about the rod or stem attached to the first sheet.

21. An article as claimed in claim 20, further comprising a plug of biocompatible material between the first and second sheets of material.

22. An article as claimed in claim 1, in the form of a three-dimensional pre-formed structure formed of sheet material, the sheet material being suitable for therapeutic use by topical application, the sheet material being flexible, hydratable, capable of bonding to tissue, and retaining its integrity on bonding, the sheet material being coiled helically to the form of an expansible roll.

23. An implantable device surrounded by an article as claimed in claim 22.

24. An article as claimed in claim 1, which incorporates a structure formed from sheet material, wherein the sheet of material is 20-1000 μm in thickness.

25. An article as claimed in claim 24, wherein the sheet of material is 100-500 μm in thickness.

26. An article as claimed in claim 24, wherein the sheet comprises a single layer of material.

27. An article as claimed in claim 24, wherein the sheet is laminated with a carrier layer of biocompatible material.

28. An article as claimed in claim 1, in the form of a tubular structure.

29. An article as claimed in claim 28, which has a diameter of from 3 mm to 20 mm, and a length of 5 mm to 600 mm.

30. An article as claimed in claim 29, which has a diameter of 6 mm to 10 mm, and a length of 10 mm to 300 mm.

31. An article as claimed in claim 1, comprising an elongate structure of part-circular cross-section.

32. An article as claimed in claim 31, which, together with one or more other such articles, forms a tubular assembly.

33. An article as claimed in claim 1, in the form of a solid plug that may be used to seal or fill a cavity or hole.

34. An article as claimed in claim 1, in the form of a solid cylindrical filament.

35. An article as claimed in claim 1, in the form of a connector for the end-to-end or end-to-side anastomotic apposition and closure of vessels.

36. An article as claimed in claim 35, in the form of a T-piece comprising a first hollow limb for receiving a first vessel and a second limb disposed substantially orthogonally thereto, for receiving a second vessel to be bonded to the first vessel.

37. An article as claimed in claim 1, in the form of a fastener for holding tissues together.

38. An article as claimed in claim 37, in the form of a staple.

39. An article as claimed in claim 38, in the form of a barbed pin.

40. An article as claimed in claim 1, in the form of a fixing plug adapted to provided an anchorage for a mechanical fastener or the like.

41. An article as claimed in claim 1, in the form of a surgical mesh.

42. An article as claimed in claim 41, which is manufactured as an integral article.

43. An article as claimed in claim 41, which is fabricated from filamentous material.

44. An article as claimed in claim 1, in the form of a scaffold for tissue regeneration.

45. An article as claimed in claim 44, which has a mesh-like structure.

46. An article as claimed in claim 1, wherein the surfaces of the article which, in use, are brought into contact with tissues are coated with a layer of fluid tissue bonding material.

47. An article as claimed in claim 1, wherein the article comprises a matrix of not only the material having tissue bonding properties but also a synthetic polymer having bioadhesive properties.

48. An article as claimed in claim 47, wherein the bioadhesive polymer component of the matrix is a polycarboxylic acid derivative, especially a copolymer of methyl vinyl ether and maleic anhydride, in the form of the anhydride, ester, acid or metal salt.

49. An article as claimed in claim 47, wherein the matrix further comprises a plasticiser.

50. An article as claimed in claim 49, wherein the plasticiser is a polyalcohol.

51. An article as claimed in claim 47, wherein the matrix also comprises a synthetic structural polymer to confer strength and elasticity on the matrix.

52. An article as claimed in claim 51, wherein the structural polymer is a water-soluble thermoplastic polymer, in particular selected from the group consisting of poly(vinyl alcohol), poly(ethylene glycol), poly(vinyl pyrrolidone), poly(acrylic acid), poly(acrylamide) and similar materials.

53. An article as claimed in claim 47, wherein the matrix comprises the following proportions of the individual components:
a) cross-linkable material—from about 2% to 80% by weight, more preferably 10% to 60%, and most preferably 30% to 50%;
b) structural polymer—from about 0.01% to 20% by weight, more preferably 1% to 15%, and most preferably 2% to 10%;
c) surfactant—from about 0.001% to 10% more preferably 0.01% to 5%, and most preferably 0.05% to 1%;
d) plasticiser—from about 0.01% to 50%, more preferably 10% to 40%, and most preferably 20% to 40%; and
e) bioadhesive polymer—from about 0.01% to 50% by weight, more preferably 1% to 40%, and most preferably 5% to 30%.

54. An article as claimed in claim 1, wherein the material contains a thermochromic compound and/or a photochromic compound.

55. An article as claimed in claim 54, which contains a chromophore which will change colour when the material has been activated by the application of light.

56. An article as claimed in claim 55, wherein the chromophore is methylene blue.

57. A process for the manufacture of an article as claimed in claim 1, which article comprises a sheet of material, which process comprises forming a film of a solution containing some or all of the components of the material, and causing or allowing the film to dry.

58. A process as claimed in claim 57, wherein the film is formed by pouring, spreading or spraying of the solution.

59. A process for the manufacture of an article as claimed in claim 1, which process comprises the step of pouring a solution containing some or all of the components of the material into a mould.

60. A process for the manufacture of an article as claimed in claim 1, which process comprises the step of extruding a solution containing some or all of the components of the material.

61. A process for the manufacture of an article as claimed in claim 1, which process comprises the fabrication of the article from smaller components.

62. A process as claimed in any one of claims 57 to 59, which process further comprises modification of the stability of the article by the application of heat, radiation or chemical agents.
